(19) United States
(12) Patent Application Publication
(10) Pub. No.: US 2008/0208727 A1
(43) Pub. Date: Aug. 28, 2008

(54) Endorsement image processing system, method and program product

(75) Inventors: Edward Joseph McLaughlin, Enfield, NH (US); William Tao-Yang Wong, San Mateo, CA (US); Bart Curtis Boster, N. Ogden, UT (US)

Correspondence Address: FOLEY AND LARDNER LLP;SUITE 500, 3000 K STREET NW, WASHINGTON, DC, 20007, US

(73) Assignee: NETDEPOSIT, INC.

(21) Appl. No.: 12/071,821

(22) Filed: Feb. 27, 2008

Related U.S. Application Data
(60) Provisional application No. 60/903,847, filed on Feb. 28, 2007.

(51) Int. Cl. G06Q 40/00

(52) U.S. Cl. 705/35

(57) ABSTRACT

A processing method, system and program product for processing checks, the system comprising: one or more computers; an electronic portal for receiving electronic data regarding an identity of a depositor for one or more checks; an association-determining electronic device for determining for each of the checks at least one business or one or more accounts associated with the identity of the depositor; wherein the one or more of computers comprise among them if more than one computer, the following components: a component for determining if the business or one or more accounts associated with the identity of the depositor is associated with a request to embed a payee endorsement in a check image file; a component for selecting based on one or more rules one from a plurality of accounts associated with the business or one of the accounts associated with the identity of the depositor if there are more than one account associated with the identity of the depositor; a component for embedding endorsement data into a image file of a face of a check; a component configured for creating a file that includes the image file of the face of the check with the embedded endorsement data therein in a file format for clearing; and a component configured for sending electronically the file to an electronic portal.

### CROSS-REFERENCE TO RELATED PATENT APPLICATIONS

This application claims priority from Provisional Application U.S. Application 60/903,847, filed Feb. 28, 2007, incorporated herein by reference in its entirety.

### SUMMARY

In one embodiment, a computer-implemented method is provided for processing checks, comprising: receiving electronically data regarding an identity of a depositor for one or more checks; determining electronically for each of the checks at least one business or one or more accounts associated with the identity of the depositor; determining if the business or one or more accounts associated with the identity of the depositor is associated with a request to embed a payee endorsement in a check image file; selecting based on one or more rules one from a plurality of accounts associated with the business or one of the accounts associated with the identity of the depositor if there are more than one account associated with the identity of the depositor; embedding endorsement data into a image file of a face of a check; creating a file that includes the image file of the face of the check with the embedded endorsement data therein in a file format for clearing; and sending electronically the file to an electronic portal.

In a further embodiment, the electronic portal is a substitute check (IRD) printer.

In a further embodiment, the file format is an ACH format and the electronic portal is an ACH method.

In a further embodiment, the file format is an image cash letter and the electronic portal is an image cash letter acceptance method.

In a further embodiment, a capability is provided of creating the file in at least two formats chosen from the group of an image replacement document format, an ACH format, and an image cash letter format.

In a further embodiment, a step is provided of inserting electronically at a point of check image capture endorsement data into a image file of a face of a check if there is only one account associated with the identity of the depositor or after the depositor has indicated an account to be deposited to.

In a further embodiment, the step is provided of sending different files to different banks of first deposit.

In a further embodiment, the step of embedding endorsement data comprises inserting the endorsement data into an image file of a back face of the check.

In a further embodiment, the step is provided of storing an image file of a back face of a check both with and without the endorsement data embedded therein.

In a further embodiment, the embedding step embeds endorsement data only if the check does not represent a return or a cancelled check.

In a further embodiment, the endorsement data is in bitmap format.

In a further embodiment, the step are provided of determining a size of the back face of the check; and adjusting a size of the endorsement data so that the endorsement data fits in a predetermined location in the image file of the check.

In a further embodiment, the step is provided of selecting electronically from among a plurality of endorsement data to be embedded into the image file of the check based on at least one criterion. In one embodiment, the criterion is one selected from the group of a designation of a bank of first deposit for the check and an account associated with the identity of the depositor.

In a further embodiment, the steps are provided of determining additional data to be embedded in the image file based on at least one criterion: and embedding the additional information into the image file of the check. In one embodiment, the criterion for determining comprises an identification of a transaction.

In a further embodiment, the additional data is added to the endorsement data prior to embedding of the endorsement data into the image file so that only a single embedding step for this check occurs.

In a further embodiment, the additional data is embedded in the image file of the check adjacent to the endorsement data.

In a further embodiment, an Internet portal is provided for administering depositor identification information and association data.

In a further embodiment, an Internet portal is provided for administering endorsement data to be embedded in checks.

In yet a further embodiment, a processing system is disclosed for processing checks, comprising: one or more computers; an electronic portal for receiving electronic data regarding an identity of a depositor for one or more checks; an association-determining electronic device for determining for each of the checks at least one business or one or more accounts associated with the identity of the depositor; wherein the one or more of computers comprise among them if more than one computer, the following components: component for determining if the business or one or more accounts associated with the identity of the depositor is associated with a request to embed a payee endorsement in a check image file; component for selecting based on one or more rules one from a plurality of accounts associated with the business or one of the accounts associated with the identity of the depositor if there are more than one account associated with the identity of the depositor; component for embedding endorsement data into a image file of a face of a check; a component configured for creating a file that includes the image file of the face of the check with the embedded endorsement data therein in a file format for clearing; and a component configured for sending electronically the file to an electronic portal.

In a yet further embodiment, a computer-usable medium is disclosed having computer readable program code embodied therein to be executed by a computer for processing checks, the computer readable program code comprising: computer code for receiving electronically data regarding an identity of a depositor for one or more checks; computer code for determining electronically for each of the checks at least one business or one or more accounts associated with the identity of the depositor; computer code for determining if the business or one or more accounts associated with the identity of the depositor is associated with a request to embed a payee endorsement in a check image file; computer code for selecting based on one or more rules one from a plurality of accounts associated with the business or one of the accounts associated with the identity of the depositor if there are more than one account associated with the identity of the depositor; computer code for embedding endorsement data into a image file of a face of a check; computer code for creating a file that includes the image file of the face of the check with the embedded endorsement data therein in a file format for clearing; and computer code for sending electronically the file to an electronic portal.

### BRIEF DESCRIPTION OF THE DRAWINGS

FIG. 1 is a schematic block diagram of an embodiment of the invention.

FIG. 2 is a flowchart of an embodiment of the invention.

FIG. 3 is an flowchart of an embodiment of the invention.

### DETAILED DESCRIPTION OF THE PREFERRED EMBODIMENTS

The invention is described below with reference to drawings. These drawings illustrate certain details of specific embodiments that implement the systems and methods of the present invention. However, describing the invention with drawings should not be construed as imposing, on the invention, any limitations that may be present in the drawings. The present invention contemplates both methods and systems for remotely accepting an instrument, such as a check, for deposit and electronically processing the deposit without need for physically routing the physical paper copy of the instrument. The embodiments of the present invention may comprise a special purpose or general-purpose computer including various computer hardware, the execution unit portion of which may also be known herein as a “processor.”

Embodiments within the scope of the present invention also include computer-readable media for carrying or having computer-executable instructions or data structures stored thereon and also known as software. Such computer-readable media can be any available media, which can be accessed by a general purpose or special purpose computer. By way of example, and not limitation, such computer-readable media can comprise RAM, ROM, EPROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions. Computer-executable instructions may also be properly termed “software” as known by those of skill in the art.

Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, mobile telephones, multi-processor systems, microprocessor-based or programmable consumer electronics, network PCs, minicomputers, mainframe computers, to name a few. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the portions of the invention includes a general purpose-computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a DVD-ROM, CD-ROM or other optical media. The drives and their associated computer-readable media provide nonvolatile storage of computer-executable instructions, data structures, program modules and other data for the computer.

Program code or software means comprising one or more program modules may be stored on the hard disk, magnetic disk, optical disk, ROM or RAM, and may include an operating system, one or more application or software programs, other program modules, and program data. In some embodiments, the program(s) may be deployed and accessible on the Internet and operate within Web browsers.

The computer may operate in a networked environment using logical connections to one or more computers having processors. Logical connections may include a local area network (LAN) and a wide area network (WAN) that are presented here by way of example and not limitation. Such networking environments are commonplace in office-wide or enterprise-wide computer networks, intranets (a network belonging to an organization, usually a corporation, accessible only by the organization's members, employees, or others with authorization). An intranet's Web sites look and act just like any other Web sites. Like the Internet itself, intranets are used to share information) and the Internet.

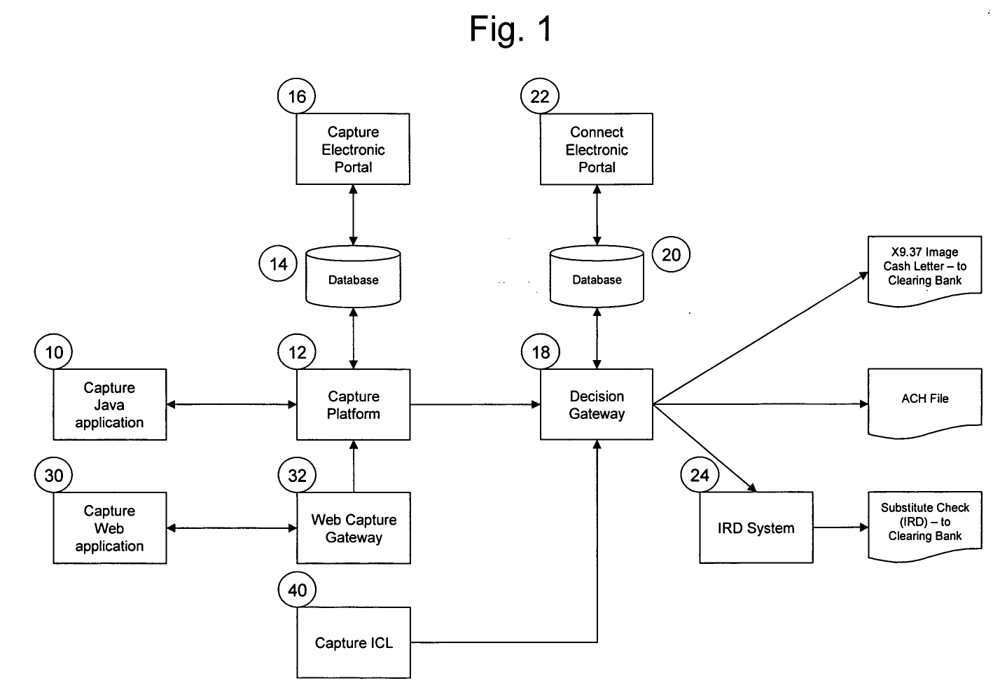

Referring now to FIG. 1, an embodiment of the invention is disclosed. Block 10 comprises one or more computers for capturing check front and back face image bitmap data, and optical recognition and/or Magnetic Ink Character Recognition of the (MICR) data and any deposit account data and depositor identification data. MICR ink is used to enable the machine recognition of numeric data printed on checks and other documents using magnetically charged ink. By way of example but not limitation, block 10 may include a check face scanning device and a MICR data reader. In one embodiment, block 10 may be implemented using a Java application. Block 10 may or may not be remotely located relative to other components of the system.

Accordingly, in one embodiment, block 10 is configured to enable a depositor to capture/convert physical paper checks and deposit slips (together, “documents”) to electronic images and data. A “depositor” is any user who is making an electronic deposit. One or more of the computers in block 10 connect to a scanner to obtain the front and rear bitmap document images and MICR data (if any on physical document). By way of example, the image file for the check may be in a raster graphics image format such as a bitmap in JPEG, PNG, GIF, TIFF, RAW, BMP, PBM, or in a vector image format. The image file format is not limiting on the invention.

Block 10 validates via one or more databases or has validated the identity of the depositor. This identity validation may be obtained remotely by connecting to another device via a network. Block 10 determines or obtains for the check (and other documents) a determination via a network of at least one business or one or more accounts associated with the identity of the depositor. The term “business” is any legal entity or company to whom the user or depositor is an employee or is affiliated.

Block 10 further determines if the business or one or more accounts associated with the identity of the depositor is associated with a request to embed a payee endorsement in a check image file.

Block 10 may include a component for selecting based on one or more rules one from a plurality of accounts associated with the business or one of the accounts associated with the identity of the depositor if there are more than one account associated with the identity of the depositor. Alternatively, block 10 may have this selection made remotely by connecting to another device via a network. Alternatively, block 10 may simply forward on the bitmap data of the check without any selection being made.

Block 10 further may comprise a component for embedding endorsement data into an image file of a face of a check. This component may be used to add the endorsement data or the check image files may be forwarded via the network for addition of the endorsement data at another block.

In one embodiment, a display screen may be included to display the front and rear document images to the depositor with and/or without digitally applied payee endorsement text. The display screen may also be used to allow the depositor to research and view document images via the network after deposit images have been uploaded.

Block 10 may also perform amount recognition, and a determination of the image quality/usability of the image files of the checks.

Block 10 prepares and uploads the electronic deposit with the image files of the check to block 12.

Referring to block 12, in one embodiment this may comprise one or more computers for accepting the check image files and MICR and deposit data for the electronic deposit from a capture client, such as block 10. Block 12 may provide the processing for performing a validation of the electronic deposit. In one embodiment, block 12 forwards the electronic deposit data including the image files of the checks, the MICR and other deposit data and identity of the depositor to a database 14. This database 14 may store user and customer configuration data, and may include any requirement for an electronic payee endorsement text application on an image of the check, by user or depositor identification. Block 12 forwards the electronic deposit including the image files to a decision gateway block 18. Referring to block 16, an electronic portal is connected for providing a Web application interface to administer and configure depositor data, customer data, and system behavior. Accordingly, via block 16 new and updated depositor identity data can be provided, and new and updated company identification and account associations can be provided, along with business rules that control such associations and account selections. In one embodiment, block 16 provides an operational Web application interface for a bank/service provider to review deposits and documents that need to be examined after capture. Block 16 may provide Web application research capabilities (e.g., search and view) to locate deposits and items from the historical deposit database 14. Authorized users can view the document check images along with electronic data associated therewith. Rear check images which have the payee endorsement text digitally applied would be viewable through this portal. In one embodiment, a function is provided to enable users to run reports that include check images. Rear check images which have the payee endorsement text digitally applied would be viewable through these reports.

Referring to block 18, a decision gateway is provided. This block comprises one or more computers connected to a network for accepting electronic deposits from different source types (e.g., the Java application of block 10, a Web application (to be discussed), and a lock box operation (to be discussed), to name a few), and determining based on system configuration and business rules how to forward the checks to the most appropriate endpoint for clearing and settlement. The block 18 decision gateway includes a component for embedding endorsement data into an image file of a face of a check, if the received electronic document comprises a check image file without a payee endorsement visible on the rear check image and if such embedding is authorized. The payee endorsement text is added digitally to the rear check image, if configured by the bank/service provider. An association-determining component may be included in block 18 for determining for each of the checks at least one business or one or more accounts associated with the identity of the depositor. Additionally, a component for selecting based on one or more rules one from a plurality of accounts associated with the business or one of the accounts associated with the identity of the depositor if there are more than one account associated with the identity of the depositor. Note that the payee endorsement text may change depending on the owner of the item and where the item is to be deposited/cleared.

The block 18 decision gateway also includes the capability to prepare files in one or more file formats, based on where and how the item is to be cleared. In one embodiment, block 18 is capable of generating with the deposit data and the check image files an outgoing image cash letter file using a file format based on ANSI X9.37 or X9.100-180. Note that the invention is not limited to a particular file format, and any appropriate file format may be used. Additionally, block 18 is capable of preparing an outgoing ACH file. Additionally, block 18 is capable of preparing outgoing substitute check cash letter instructions (including the check image files and data) for forwarding to an image replacement document generation facility. In one embodiment, each of these files would be sent to a different electronic portal, e.g., a cash letter portal, an ACH portal, and an IRD facility. The term “electronic portal” is to be interpreted broadly to include any electronic gateway, including, but not limited to an Internet portal.

In one embodiment, the decision gateway block 18 may include a multi-tier organizational hierarchy. Such a hierarchy allows the system to express business rules and configuration parameters (such as the payee endorsement) at different levels of organizational hierarchy. For example, one embodiment of an organizational hierarchy may begin with a “bank,” then a “corporate customer,” then a “client.” Thus, depending on the corporate customer, the customer may have multiple locations or multiple bank accounts. The multi-tier hierarchy allows such relationships to be captured and expressed. For example, a corporate customer may only want one payee endorsement, so that the payee endorsement is attached at the customer level of the hierarchy. Alternatively, a customer with multiple accounts may need multiple payee endorsements (one for each account). Thus, the system would attach the payee endorsement at the “client” level, where there is a one to one relationship between the client and payee endorsement.

In one embodiment, block 18 will determine for an inbound file with a check for deposit whether an <EmbedPayeeEndorse> parameter is True. This parameter may be in the received file or may be associated with the identity of the depositor or an account in the system. If this parameter is True, the system checks its database to determine if a payee endorsement has been configured at either the customer or the client level for the incoming file. If the system determines that there is a payee endorsement configured at either level, and the system is set for generating a substitute check cash letter instructions, then the file bundler is set to suppress the sending of the payee endorsement in any standard bundle files, and a rear image of the check in the file is located. The system determines if an EPC code in the file designates the check as an image replacement document (IRD). If the EPC code indicates that the document is an IRD, then the payee endorsement must be rendered in a different location within the back image. The system then determines the size of the rear image so that the endorsement can be formatted correctly within the image, e.g., retaining a desired margin, adjusting font size, to name a few, so that the entire text of the payee endorsement fits on the check image without being cut off at either edge. A log is maintained of all changes made to the check, and an error level message is logged so that the system or a technician may identify the source file, cash letter, bundle, item and image with the error. Typically, the log would contain the file name, cash letter ID, bundle ID, item sequence number and GUID of the offending item.

Block 18 in one embodiment, uploads the electronic deposits including the image files to a bank or service provider image archive 20. Additionally, block 18 may create a log, as noted above, indicating/tracking how a deposit item was received and how the deposit item was sent for clearing.

Additionally, block 18 includes a component for transmitting the check deposit data for different depositors to different respective banks of first deposit.

In one embodiment, an electronic portal 22 may be provided with an administrative Web application interface to administer and configure users, customers, and system behavior. Accordingly, via portal 22 new and updated depositor identity data may be provided, and new and updated company identification and account associations can be provided, along with business rules that control such associations and account selections. In one embodiment, the electronic portal 22 may be provided with research capabilities (e.g., search and view) to locate deposits and items from the historical deposit database. Authorized users can view the document check images along with electronic data. Rear check images which have the payee endorsement text digitally applied would be viewable through this portal. In one embodiment, users would be enabled to run reports that include check images.

Referring in more detail to the image cash letter file format generated in block 18, the X9.37 or X9.100-180 image cash letter may be composed of check image files, MICR, and endorsement data records (payee and/or bank). Within an image cash letter, checks that have had payee endorsement text digitally applied to the rear check image may also have endorsement data records. Accordingly, downstream banks can view the rear check images with digitally applied payee endorsement texts without needing to change their existing/legacy systems to deal with the endorsement data records.

Referring in more detail to the ACH file format generated in block 18, the ACH file may be composed of MICR and other electronic data records acceptable to an originating depository financial institution (ODFI). The check image files including the image of the back of the check with the endorsement data embedded therein are stored in database 20 and are available to resolve any ACH returned items.

Referring in more detail to the image replacement document (IRD) file format, the image files of the check are included, along with the MICR and other deposit data, including an identification of the clearing endpoint for the check. As noted, block 18 provides the IRD format file to an IRD processing block 24. Block 24 processes the substitute check cash letter instructions (check image files and data) received from block 18 decision gateway into print files in an appropriate printer command language (e.g., PostScript, PCL) following the X9.100-140 standard, for example. Block 24 then forwards the print file to a printer (not shown) to generate the physical substitute checks with the payee endorsement visible on the rear of the substitute check. If configured by bank/service provider, block 24 embeds within the print file the printer instructions for printing the payee endorsement text (and/or any other endorsements) on the rear of the substitute check. Note that this is an option for the bank or service provider because there are use cases where the bank or service provider may not wish to print a payee endorsement on the back of a substitute check. For instance, if block 24 is being used in the context of a return cash letter, there may not be a payee endorsement available. In one embodiment, block 24 may be a general purpose processor that converts substitute check cash letter instructions into substitute checks. Because substitute checks can be used for different business cases, it is not always required that payee or bank endorsements be applied on the back of a substitute check. In the forward presentment case such endorsements would be the norm, but in a situation where someone was trying to generate substitute checks for sending cancelled checks as part of a paper statement, the endorsement would not be necessary.

Referring now to block 30, an alternative device for capturing check deposits is provided by a Web application. The Web application enables a depositor to capture/convert physical paper checks and deposit slips (together, “documents”) to electronic images and data. The application runs within a Web browser and may connect to a scanner to obtain the front and rear document images and MICR data (if any on the physical document). The application sends the document images and MICR data to a Web capture gateway 32 for validation and processing. The application is configured to display the front and rear check image files to the depositor. Additionally, the application is configured to prompt the depositor to correct any issues found by the Web capture gateway 32. The application also is configured to display the rear check image file with and without digitally applied payee endorsement text added by the Web gateway block 32.

Referring to the Web capture gateway block 32, this block receives the document image files and MICR data from the Web client block 30 via the Web. Block 32 stores the document images and MICR data in its database. Block 32 performs identity validation, amount recognition, and image quality/usability determination. Note that the identity validation may be obtained remotely by connecting to another device via a network. It provides the images and any correction instructions back to the NetCapture Business web client. Block 32 determines or obtains a determination via a network for the check of at least of one business or one or more accounts associated with the identity of the depositor. Block 32 further determines if the business or one or more accounts associated with the identity of the depositor is associated with a request to embed a payee endorsement in a check image file. Block 32 may include a component for selecting based on one or more rules one from a plurality of accounts associated with the business or one of the accounts associated with the identity of the depositor if there are more than one account associated with the identity of the depositor. Alternatively, block 32 may have this selection made remotely by connecting to another device via a network. Alternatively, block 32 may simply forward on the bitmap data of the check without any selection being made. If the captured document is a check, block 32 may embed the payee endorsement text digitally to the rear check image file, if configured by user or centrally by bank/service provider and the correct endorsement data can be obtained. Block 32 then prepares and uploads the electronic deposit to block 12.

Referring now to block 40, this block accepts X9.37 (and other formats) image cash letters from external sources (e.g., corporations, banks). For example, block 40 may be receiving checks from a lock box from a corporate customer such as a power company. Block 40 also performs or has performed identity validation, amount recognition, and an image quality/usability determination. Block 40 determines or obtains a determination via the network for the check of at least of one business or one or more accounts associated with the identity of the depositor. Block 32 further determines if the business or one or more accounts associated with the identity of the depositor is associated with a request to embed a payee endorsement in a check image file. Block 40 may include a component for selecting based on one or more rules one from a plurality of accounts associated with the business or one of the accounts associated with the identity of the depositor if there are more than one account associated with the identity of the depositor. Alternatively, block 40 may have this selection made remotely via a network. Alternatively, block 40 may simply forward on the bitmap data of the check without any selection being made. If the captured document is a check, block 40 may embed the payee endorsement text digitally to the rear check image file, if configured by user or centrally by bank/service provider and the correct endorsement data can be obtained. Block 40 then forwards the resultant image cash letter to the block 18 decision gateway.

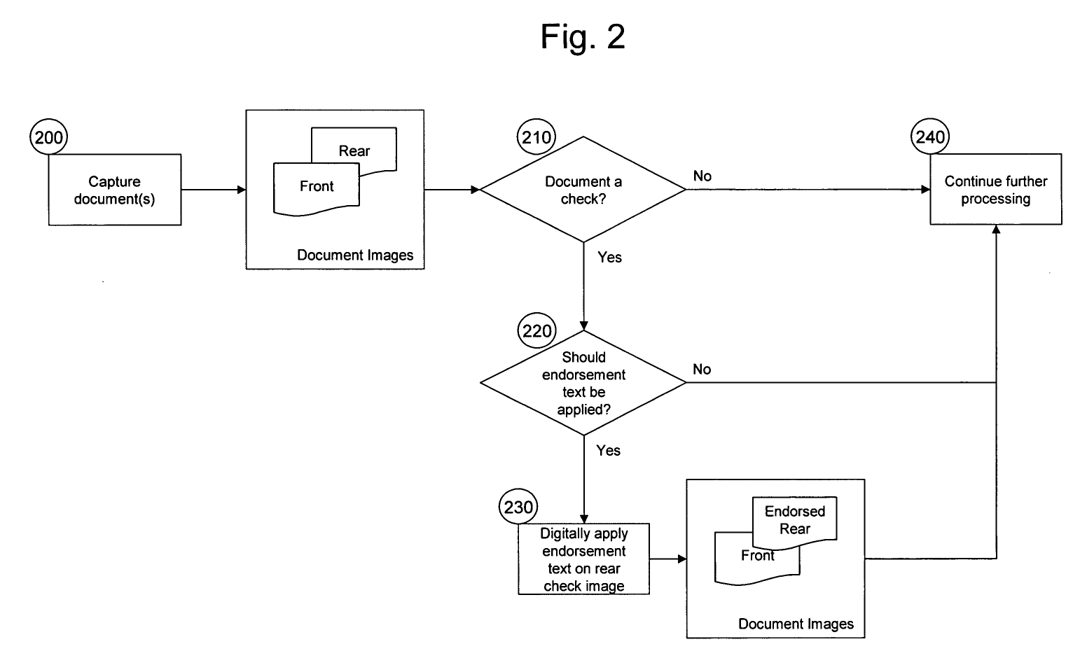

Referring now to FIG. 2, a flowchart description is provided for one embodiment of the invention. Block 200 represents the operation of capturing the deposit documents, including obtaining an image file of the front and back faces of any checks.

Block 210 represents the operation of the system determining whether each captured document is a check using characteristics of the document (e.g., MICR line, OCR/ICR). If the determination is NoCheck, then the process proceeds to block 240 for further processing.

If block 210 determines that the document is a check, then in block 220 the operation is represented of determining if endorsement text is required to be applied digitally to the back image file of the check. This determination is based on one or more criteria, such as the identity of the depositor, or an associated account number or employer or location. If the answer is No, then the process proceeds to block 240 for further processing.

If payee endorsement data is to be added, then block 230 represents the operation of selecting the correct endorsement data (where a selection is necessary) and embedding the endorsement data in the image file of the rear face of the check. Documents are then forwarded to the next step of the system workflow.

In one embodiment, the system could be configured to determine which customer account should be associated with the deposit when the depositor is identified (e.g., logs in to the system). The depositor (customer employee) could also be asked to make the selection of which depository account to deposit, if the depositor can deposit to two or more depository accounts. Alternatively, the system could be configured to simply have the depositor capture and deposit the checks with the system (in one embodiment, the decision gateway block 18) making the decision of which customer account should be associated to the checks (NOT the deposit itself).

For example, assume that customer has 5 depository accounts with one or more banks. The system determines that the items are associated with customer by means of the identity of the depositor and his/her association with the customer or another means. After the check has been accepted and associated with customer, the check is forwarded (with the association) to the decision gateway block 18. The decision gateway block 18 would then be configured such that checks within a deposit associated with customer are sorted to the 5 depository accounts based on one or more business rules, such as:
a. characteristics of the MICR line such as the Route Transit Number where the check was drawn from, it is a personal check versus a business check
b. who submitted the deposit (e.g., customer, or customer San Diego Sales Region)
c. time of day
d. cost of the item to clear
e. additional parameters or instructions that might accompany the item (“the check writer opts out of ACH”)
f. check amount

Based on these business rules, the decision gateway block 18 decides to send a specific check to one of the 5 depository accounts.

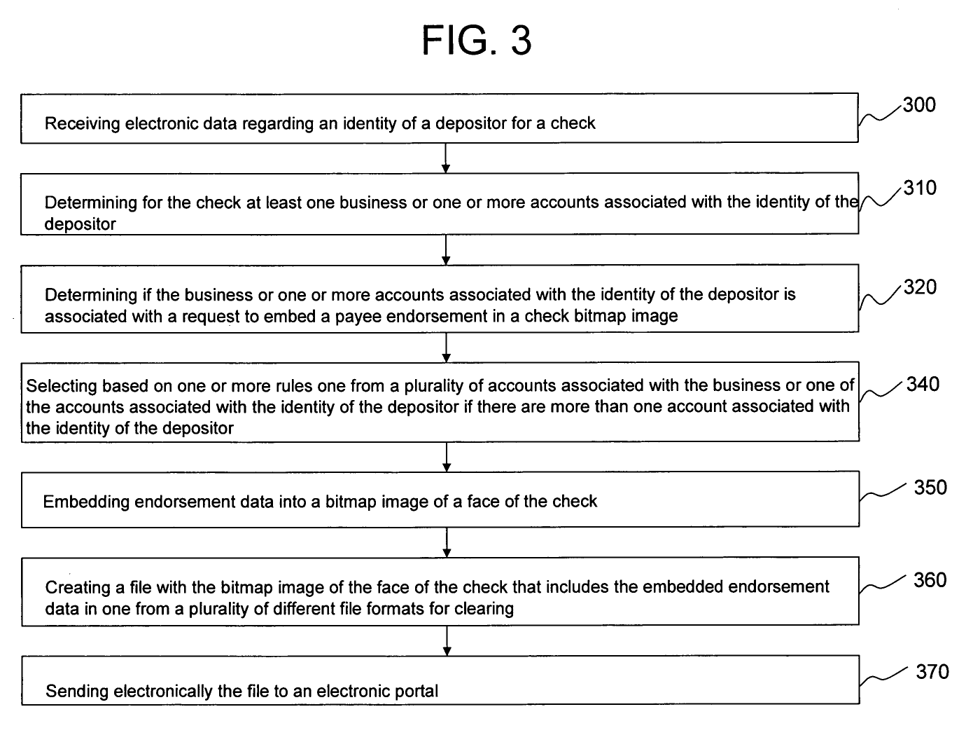

Referring to FIG. 3, an embodiment of a method of the present invention is disclosed. Block 300 comprises an operation of receiving electronic data regarding an identity of a depositor for one or more received checks. With reference to FIG. 1, this operation could be performed, for example, in blocks 10, 30 and 40.

Block 310 represents the operation of determining for each of the checks at least one business or one or more accounts associated with the identity of the depositor. With reference to FIG. 1, this operation could be performed in any of a variety of blocks including blocks 10, 12, 18, 30, 32, and 40.

Block 320 represents the operation of determining if the business or one or more accounts associated with the identity of the depositor is associated with a request to embed a payee endorsement in a check image file. Note that a single account number may be associated with the identity of the depositor. Alternatively, the depositor may be an employee of a corporation which has five separate accounts associated therewith.

Block 330 represents the operation of selecting based on one or more rules one from a plurality of accounts associated with the business or one of the accounts associated with the identity of the depositor for example if there are more than one account associated with the identity of the depositor.

In one embodiment, the endorsement data is in a bitmap format. In another embodiment, the endorsement data is in a textual form.

In one embodiment, the system may further include a component and operation of selecting electronically from among a plurality of endorsement data to be embedded into the image file of the check based on at least one criterion. In one embodiment, the criterion is one selected from the group of a designation of a bank of first deposit for the check and an account associated with the identity of the depositor.

In a further embodiment, the system may include a component and operation for determining additional data to be embedded in the image file along with the endorsement data based on at least one criterion, and a component and operation for embedding the additional information into the image file of the check. In one embodiment, the criterion for determining comprises an identification of a transaction. Such transaction identification may comprise an accounts receivable designation number or an invoice number, for example. In one embodiment, this additional data is added to the endorsement data prior to embedding of the endorsement data into the image file so that only a single embedding step for this check occurs. For example, the additional data may be embedded in the image file of the check adjacent to the endorsement data.

Block 340 represents the operation of embedding endorsement data into a image file of a face of a check. By way of example, the image file for the check may be in a raster graphics image format such as a bitmap in JPEG, PNG, GIF, TIFF, RAW, BMP, PBM, or in a vector image format. This operation may be accomplished at the point where the check image is captured, if there is only one account associated with the identity of the depositor, or if information is obtained about the correct endorsement data to be embedded. Alternatively, the endorsement data can be embedded in the image file of the check at any convenient point, such as in the decision gateway block. In one embodiment, the image file of the back of the check is opened and payee endorsement data is retrieved and overlaid in a payee endorsement area on the image file of the back of the check and embedded to create a modified image file of the bank of the check. This modified image file is then inserted into the deposit file. This embedding process is followed for each check item in the deposit file.

In one embodiment, the embedding component could further comprise a component for determining a size of the back face of the check, and a component for adjusting a size of the endorsement data so that the endorsement data fits in a predetermined location within the image file of the check. This is a useful feature in that checks vary in size. This size variation is particularly pronounced for image replacement documents (IRD's).

In one embodiment, the system includes a component for determining if a check is a return, and if so, then preventing the embedding of endorsement data on the return check. Block 350 represents the operation of creating a file with the image file of the face of the check that includes the embedded endorsement data in a file format for clearing. By way of example, the file format could be an ACH file, or a cash letter file, or a file with instructions for creating an image replacement document (IRD).

Block 360 represents the operation of sending electronically the file to an electronic portal, such as a clearing bank, or an ACH processor, or an IRD printer system.

Note that the decision gateway block 18 will also send a communication to the bank of first deposit for the respective customer. This communication will include the amounts of the checks, and in some embodiments, may include the image files of the checks in the deposit with the endorsement data embedded therein. As this system may be designed to process deposits for multiple customers, with different respective banks of first deposit, the system of the present invention is capable of sending communications regarding deposits to multiple banks of first deposit.

In one embodiment, an Internet portal may be included in the system for administering depositor identification information and association data. For example, users may access the database 14 of FIG. 1 in order to add or change depositor identifications information and to add or change the companies or accounts associated with the depositor identification. The database 14 may also include storage of a image file of a back face of a check both with and without the endorsement data embedded therein. These image files may be viewed through this portal. Additionally, a different Internet portal or the same Internet portal may be used for administering endorsement data to be embedded in checks.

Accordingly, a system and method have been provided for application of payee endorsement text (and other endorsement texts) digitally on the rear check image at various stages of the remote deposit capture workflow, depending on business and operational requirements. Thus, downstream systems are able to process checks based on the embedded endorsement text and users are able to view the endorsement text embedded within the rear check image without significant change to their systems. This is particularly useful in that many systems can not interpret and display the payee endorsement data record provided by current X9.37 image cash letters where the electronic payee endorsement data record accompanies the check images. Some embodiments of the system and method provide the ability for business rules to place varying payee endorsement texts on the rear check image in a dynamic fashion. Embodiments of the system reduce a need for users to manually place payee endorsement on the rear of each check.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or manual operations.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A processing system for processing checks, comprising:
one or more computers;
an electronic portal for receiving electronic data regarding an identity of a depositor for one or more checks;
an association-determining electronic device for determining for each of the checks at least one business or one or more accounts associated with the identity of the depositor;
wherein the one or more of computers comprise among them if more than one computer, the following components:
a component for determining if the business or one or more accounts associated with the identity of the depositor is associated with a request to embed a payee endorsement in a check image file;
a component for selecting based on one or more rules one from a plurality of accounts associated with the business or one of the accounts associated with the identity of the depositor if there are more than one account associated with the identity of the depositor;
a component for embedding endorsement data into an image file of a face of a check;
a component configured for creating a file that includes the image file of the face of the check with the embedded endorsement data therein in a file format for clearing; and
a component configured for sending electronically the file to an electronic portal.

2. The system as defined in claim 1, wherein the electronic portal is a substitute check (IRD) printer.

3. The system as defined in claim 1, wherein file format is an ACH format and the electronic portal is an ACH system.

4. The system as defined in claim 1, wherein the file format is an image cash letter and the electronic portal is an image cash letter acceptance system.

5. The system as defined in claim 1, wherein the component for creating the file is capable of creating the file in at least two formats chosen from the group of an image replacement document format, an ACH format, and an image cash letter format.

6. The system as defined in claim 1, further comprising inserting electronically at a point of check image capture endorsement data into an image file of a face of a check if there is only one account associated with the identity of the depositor or after the depositor has indicated an account to be deposited to.

7. The system as defined in claim 1, further comprising a component for sending different files to different banks of first deposit.

8. The system as defined in claim 1, wherein the component for embedding endorsement data comprises inserts the endorsement data into an image file of a back face of the check.

9. The system as defined in claim 8, further comprising storing an image file of a back face of a check both with and without the endorsement data embedded therein.

10. The system as defined in claim 1, wherein the component for embedding embeds endorsement data only if the check does not represent a return or a cancelled check.

11. The system as defined in claim 1, wherein the endorsement data is in bitmap format.

12. The system as defined in claim 1, further comprising:
a component for determining a size of the back face of the check; and
a component for adjusting a size of the endorsement data so that the endorsement data fits in a predetermined location in the image file of the check.

13. The system as defined in claim 1, further comprising
A component for selecting electronically from among a plurality of endorsement data to be embedded into the image file of the check based on at least one criterion.

14. The system as defined in claim 13, wherein the criterion is one selected from the group of a designation of a bank of first deposit for the check and an account associated with the identity of the depositor.

15. The system as defined in claim 1, further comprising:
a component for determining additional data to be embedded in the image file based on at least one criterion: and
a component for embedding the additional information into the image file of the check.

16. The system as defined in claim 15, wherein the criterion for determining comprise an identification of a transaction.

17. The system as defined in claim 15, wherein the additional data is added to the endorsement data prior to embedding of the endorsement data into the image file so that only a single embedding step for this check occurs.

18. The system as defined in claim 15, wherein the additional data is embedded in the image file of the check adjacent to the endorsement data.

19. The system as defined in claim 1, further comprising providing an Internet portal for administering depositor identification information and association data.

20. The system as defined in claim 1, further comprising providing an Internet portal for administering endorsement data to be embedded in checks.

21. A computer-implemented method for processing checks, comprising:
receiving electronically data regarding an identity of a depositor for one or more checks;
determining electronically for each of the checks at least one business or one or more accounts associated with the identity of the depositor;
determining if the business or one or more accounts associated with the identity of the depositor is associated with a request to embed a payee endorsement in a check image file;
selecting based on one or more rules one from a plurality of accounts associated with the business or one of the accounts associated with the identity of the depositor if there are more than one account associated with the identity of the depositor;
embedding endorsement data into an image file of a face of a check;
creating a file that includes the image file of the face of the check with the embedded endorsement data therein in a file format for clearing; and
sending electronically the file to an electronic portal.

22. The method as defined in claim 21, wherein the electronic portal is a substitute check (IRD) printer.

23. The method as defined in claim 21, wherein file format is an ACH format and the electronic portal is an ACH method.

24. The method as defined in claim 21, wherein the file format is an image cash letter and the electronic portal is an image cash letter acceptance method.

25. The method as defined in claim 21, further comprising providing a capability of creating the file in at least two formats chosen from the group of an image replacement document format, an ACH format, and an image cash letter format.

26. The method as defined in claim 21, further comprising inserting electronically at a point of check image capture endorsement data into an image file of a face of a check if there is only one account associated with the identity of the depositor or after the depositor has indicated an account to be deposited to.

27. The method as defined in claim 21, further comprising sending different files to different banks of first deposit.

28. The method as defined in claim 21, wherein the step of embedding endorsement data comprises inserting the endorsement data into an image file of a back face of the check.

29. The method as defined in claim 28, further comprising storing an image file of a back face of a check both with and without the endorsement data embedded therein.

30. The method as defined in claim 21, wherein the embedding step embeds endorsement data only if the check does not represent a return or a cancelled check.

31. The method as defined in claim 21, wherein the endorsement data is in bitmap format.

32. The method as defined in claim 21, further comprising:
determining a size of the back face of the check; and
adjusting a size of the endorsement data so that the endorsement data fits in a predetermined location in the image file of the check.

33. The method as defined in claim 21, further comprising
selecting electronically from among a plurality of endorsement data to be embedded into the image file of the check based on at least one criterion.

34. The method as defined in claim 33, wherein the criterion is one selected from the group of a designation of a bank of first deposit for the check and an account associated with the identity of the depositor.

35. The method as defined in claim 21, further comprising:
determining additional data to be embedded in the image file based on at least one criterion: and
embedding the additional information into the image file of the check.

36. The method as defined in claim 35, wherein the criterion for determining comprise an identification of a transaction.

37. The method as defined in claim 35, wherein the additional data is added to the endorsement data prior to embedding of the endorsement data into the image file so that only a single embedding step for this check occurs.

38. The method as defined in claim 35, wherein the additional data is embedded in the image file of the check adjacent to the endorsement data.

39. The method as defined in claim 21, further comprising providing an Internet portal for administering depositor identification information and association data.

40. The method as defined in claim 21, further comprising providing an Internet portal for administering endorsement data to be embedded in checks.

41. A computer-usable medium having computer readable program code embodied therein to be executed by a computer for processing checks, the computer readable program code comprising:
computer code for receiving electronically data regarding an identity of a depositor for one or more checks;
computer code for determining electronically for each of the checks at least one business or one or more accounts associated with the identity of the depositor;
computer code for determining if the business or one or more accounts associated with the identity of the depositor is associated with a request to embed a payee endorsement in a check image file;
computer code for selecting based on one or more rules one from a plurality of accounts associated with the business or one of the accounts associated with the identity of the depositor if there are more than one account associated with the identity of the depositor;
computer code for embedding endorsement data into a image file of a face of a check;
computer code for creating a file that includes the image file of the face of the check with the embedded endorsement data therein in a file format for clearing; and
computer code for sending electronically the file to an electronic portal.
